(19) United States
(12) Patent Application Publication
(10) Pub. No.: US 2014/0080941 A1
(43) Pub. Date: Mar. 20, 2014

(54) INSULATING COMPOSITION FOR MULTILAYER PRINTED CIRCUIT BOARD, METHOD FOR PREPARING THE SAME, AND MULTILAYER PRINTED CIRCUIT BOARD COMPRISING THE SAME AS INSULATING LAYER

(71) Applicant: SAMSUNG ELECTRO-MECHANICS CO., LTD., Suwon-si (KR)

(72) Inventors: Sa Yong LEE, Suwon-si (KR); Jin Young KIM, Suwon-si (KR); Jin Ho HONG, Suwon-si (KR); Keun Yong LEE, Suwon-si (KR)

(73) Assignee: SAMSUNG ELECTRO-MECHANICS CO., LTD., Suwon-si (KR)

(21) Appl. No.: 14/026,134

(22) Filed: Sep. 13, 2013

(30) Foreign Application Priority Data
Sep. 14, 2012 (KR) 10-2012-0102082

(51) Int. Cl. H01B 3/40

(52) U.S. Cl. CPC H01B 3/40
USPC 523/456

(57) ABSTRACT

The present invention relates to an insulating composition for a multilayer printed circuit board including: nanoclay 0.5 to 10 wt %, a soluble liquid crystal oligomer 5 to 50 wt %, an epoxy resin 5 to 50 wt %, a solvent 5 to 40 wt %, and an inorganic filler 50 to 80 wt %, a prepreg and an insulating film using the composition, and a multilayer printed circuit board including the prepreg and the insulating film as an interlayer insulating layer. Accordingly, the composition prepared by mixing nanoclay with the soluble liquid crystal oligomer (LCO), the epoxy resin, and the inorganic filler having excellent thermal, electrical, and mechanical characteristics can be implemented as a substrate insulating material such as a prepreg or a film which can implement a low efficient of thermal expansion, high rigidity, and high thermal characteristics required for a package substrate with advanced specifications.

### CROSS-REFERENCE TO RELATED APPLICATIONS

Claim and incorporate by reference domestic priority application and foreign priority application as follows:

### CROSS REFERENCE TO RELATED APPLICATION

This application claims the benefit under 35 U.S.C. Section 119 of Korean Patent Application Serial No. 10-2012-0102082, entitled filed Sep. 14, 2012, which is hereby incorporated by reference in its entirety into this application.”

### BACKGROUND OF THE INVENTION

1. Field of the Invention

The present invention relates to an insulating composition for a multilayer printed circuit board, a method for preparing the same, and a multilayer printed circuit board comprising a prepreg and an insulating film using the insulating composition as an insulating layer.

2. Description of the Related Art

With the advance of electronic devices, printed circuit boards are becoming lighter, thinner, and smaller day by day. In order to meet these requirements, circuit-patterning of a printed circuit board is becoming more complicated and narrower. Electrical, thermal, and mechanical characteristics required for a printed circuit board serve as more important factors.

A printed circuit board chiefly comprises copper serving as circuit wiring and a polymer serving as an interlayer insulator. The polymer constituting an insulation layer requires several characteristics such as coefficient of thermal expansion (CTE), permittivity, dielectric loss, and thickness uniformity compared to copper. Especially, in a process of mounting electronic and electric devices, in order to minimize warpage occurring during a reflow process, low CTE, high glass transition temperature (Tg), and high modulus are required.

In recent times, with the advance of electronic devices, several ways to improve mechanical, electrical, and thermal characteristics of an insulating layer of a multilayer printed circuit board used in electronic devices have been studied.

Many studies of methods of preparing an insulating material by filling ceramic such as silica or alumina in an organic resin matrix consisting of epoxy, polyimide, aromatic polyester, or aromatic polyester amide have been made but the degree thereof is not sufficient.

### RELATED ART DOCUMENT

### Patent Document

Patent Document 1: Japanese Patent Laid-Open No. 2012-92303

### SUMMARY OF THE INVENTION

The present invention has been invented in order to overcome the above-described problems and it is, therefore, an object of the present invention to provide an insulating composition for a multilayer printed circuit board with excellent thermal characteristics and mechanical stability.

Further, it is another object of the present invention to provide a method for preparing an insulating composition.

Further, it is still another object of the present invention to provide a prepreg and an insulating film using an insulating composition.

Further, it is still another object of the present invention to provide a multilayer printed circuit board comprising a prepreg and an insulating film using an insulating composition as an interlayer insulating layer.

In accordance with one aspect of the present invention to achieve the object, there is provided an insulating composition for a multilayer printed circuit board including: nanoclay 0.5 to 10 wt %, a soluble liquid crystal oligomer 5 to 50 wt %, an epoxy resin 5 to 50 wt %, a solvent 5 to 40 wt %, and an inorganic filler 50 to 80 wt %.

It is preferred that the nanoclay is montmorillonite surface-treated with cations; or montmorillonite surface-treated with quaternary ammonium salt containing aliphatic hydrocarbon or an alkyl group having 6 to 18 carbon atoms.

The nanoclay may be completely split dispersed in the soluble liquid crystal oligomer or the epoxy resin in the form of a nanometer-thick plate or the nanoclay may be included in the form of a composite with the soluble liquid crystal oligomer or the epoxy resin.

It is preferred that the liquid crystal oligomer includes hydroxyl groups and nadimide functional groups at terminals thereof.

It is preferred that a number average molecular weight (Mn) of the liquid crystal oligomer is 3000 to 5000 g/mol.

It is preferred that the epoxy resin is a multifunctional epoxy resin having two or more epoxy groups in one molecule.

It is preferred that a diameter of the inorganic filler is 0.05 to 2 μm.

It is preferred that the inorganic filler is at least one selected from the group consisting of natural silica, fused silica, amorphous silica, hollow silica, aluminum hydroxide, boehmite, magnesium hydroxide, molybdenum oxide, zinc molybdate, zinc borate, zinc stannate, aluminum borate, potassium titanate, magnesium sulfate, silicon carbide, zinc oxide, boron nitride (BN), silicon nitride, silicon oxide, aluminum titanate, barium titanate, barium strontium titanate, aluminum oxide, alumina, clay, kaoline, talc, calcined clay, calcined kaoline, calcined talc, mica, short glass fibers, and mixtures thereof.

The solvent may be at least one selected from the group consisting of N,N′-dimethylformamide (DMF), N,N′-dimethylacetamide (DMAc), N-methylpyrrolidone (NMP), dimethyl sulfoxide (DMSO), N-methylpropionamide, N-methylcaprolactam, γ-butyrolactone, dimethylimidazolidinone, tetramethylphosphoric amide, ethyl cellosolve acetate, methyl ethyl ketone (MEK), propylene glycol monomethyl ether acetate (PGMEA), and combinations thereof.

Additionally, the composition may further include at least one rubber component selected from the group consisting of elastomers such as polyurethane resins, polybutadiene, butadiene-acrylonitrile copolymers, polychloroprene, butadiene-styrene copolymers, polyisoprene, butyl rubber, fluorinated rubber, and natural rubber, styrene-isoprene rubber, acrylic rubber, epoxidized butadiene, and maleated butadiene.

It is preferred that the rubber component is included in an amount of 0.5 to 10 wt % based on the total composition.

Further, in accordance with another aspect of the present invention to achieve the object, there is provided a method for preparing an insulating composition for a multilayer printed circuit board including the steps of: dispersing nanoclay in a solvent; mixing a liquid crystal oligomer with the dispersion; and mixing an epoxy resin and an inorganic filler with the mixture.

The solvent may be at least one selected from the group consisting of N,N′-dimethylformamide (DMF), N,N′-dimethylacetamide (DMAc), N-methylpyrrolidone (NMP), dimethyl sulfoxide (DMSO), N-methylpropionamide, N-methylcaprolactam, γ-butyrolactone, dimethylimidazolidinone, tetramethylphosphoric amide, ethyl cellosolve acetate, methyl ethyl ketone (MEK), propylene glycol monomethyl ether acetate (PGMEA), and combinations thereof.

It is preferred that the nanoclay is split dispersed in the form of a plate with a thickness of 1.0 to 100 nm.

Further, in accordance with still another aspect of the present invention to achieve the object, there is provided a prepreg or an insulating film using an insulating composition.

Further, in accordance with still another aspect of the present invention to achieve the object, there is provided a multilayer printed circuit board including a prepreg or an insulating film using an insulating composition as an interlayer insulating layer.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 shows scanning electron microscope cross-section (a) and image photograph (b) of an insulating film prepared from an insulating composition according to a comparative example 1; and

FIG. 2 shows scanning electron microscope cross-section (a) and image photograph (b) of an insulating film of an embodiment 2.

### DETAILED DESCRIPTION OF THE PREFERABLE EMBODIMENTS

Hereinafter, the present invention will be described in detail.

Terms used herein are provided to explain embodiments, not limiting the present invention. Throughout this specification, the singular form includes the plural form unless the context clearly indicates otherwise. Further, terms “comprises” and/or “comprising” used herein specify the existence of described shapes, numbers, steps, operations, members, elements, and/or groups thereof, but do not preclude the existence or addition of one or more other shapes, numbers, operations, members, elements, and/or groups thereof.

The present invention relates to an insulating composition for a multilayer printed circuit board with excellent thermal and mechanical characteristics, a prepreg and an insulating film using the same, and a multilayer printed circuit board comprising the prepreg and the insulating film as an interlayer insulating layer.

An insulating composition in accordance with an embodiment of the present invention includes nanoclay 0.5 to 10 wt %, a soluble liquid crystal oligomer 5 to 50 wt %, an epoxy resin 5 to 50 wt %, a solvent 5 to 40 wt %, and an inorganic filler 50 to 80 wt %.

In the present invention, the nanoclay is used to reduce a coefficient of thermal expansion and implement a high glass transition temperature or a high modulus by forming a composite with a resin polymer such as a soluble liquid crystal oligomer or an epoxy resin.

It is preferred that the nanoclay of the present invention is montmorillonite surface-treated with cations such as calcium (Ca) or sodium (Na); or montmorillonite surface-treated with quaternary ammonium salt containing aliphatic hydrocarbon or an alkyl group having 6 to 18 carbon atoms. Therefore, a polar group such as cations or quaternary ammonium slat containing aliphatic hydrocarbon or an alkyl group is bonded to a surface of the nanoclay.

It is preferred that the content of the nanoclay in accordance with the present invention is 0.5 to 10 wt % based on the total insulating composition. When the content of the nanoclay is less than 0.5 wt %, improvement of mechanical and thermal characteristics is insufficient, and when the content of the nanoclay exceeds 10 wt %, it is not preferred due to deterioration of dispersibility.

According to dispersion characteristics of the nanoclay, the nanoclay may be completely split dispersed in the form of a plate with a thickness of several nanometers (nm) to be mixed with the LCO or the epoxy resin or less split dispersed in the form of a plate with a thickness of several tens or hundreds of nanometers or micrometers to form a composite with the LCO or the epoxy resin.

Here, the split dispersion of the nanoclay means that the nanoclay is dispersed while maintaining a plate shape as it is. Further, the “complete split dispersion” means that the nanoclay in accordance with the present invention is dispersed with a smaller size than an original size while maintaining an original plate shape. A sum of a single layer thickness (9.6 Å) and an interlayer distance represents a repeat unit of a multilayer material, so called d-spacing or basal spacing, and is calculated from (001) harmonics of X-ray diffraction patterns. Montmorillonite, as an example of the nanoclay in accordance with the present invention, can be perfectly split dispersed when having a thickness of 9.6 Å to 200 Å.

Further, the soluble liquid crystal oligomer in accordance with the present invention includes an amide group, which gives solubility, and a naphthalene group, which gives liquid crystalline properties, and a phosphorous component to implement flame retardancy.

Further, the soluble liquid crystal oligomer in accordance with the present invention includes hydroxyl groups or nadimide groups at both terminals and a carbonyl group (C═O) at a main chain and reacts with the epoxy resin or the cations or the quaternary ammonium salt containing aliphatic hydrocarbon or an alkyl group on the surface of the nanoclay included in the insulating composition to improve mechanical properties.

An example of the soluble liquid crystal oligomer in accordance with the present invention may be represented as a structure of the following chemical formula 1 or 2, and a, b, c, d, and e in the chemical formulas 1 and 2 represent mole ratios of repeat units and are determined based on the content of a starting material.

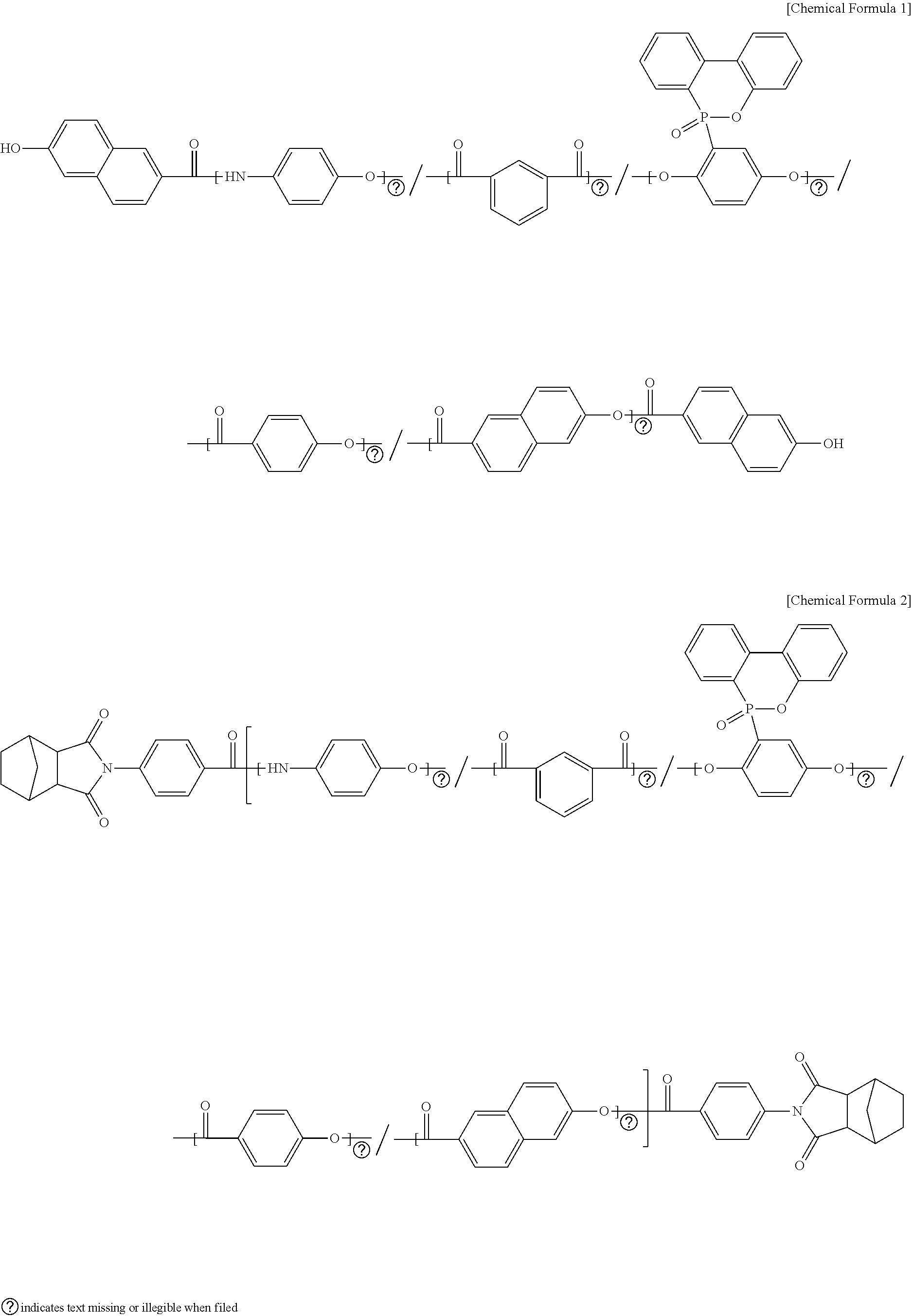

The soluble liquid crystal oligomer in accordance with the present invention has a number average molecular weight of 3000 to 5000 g/mol to exhibit a proper crosslinking density, secure heat-resistance, have excellent solubility characteristics for the solvent, and exhibit manufacture processibility of a film and a prepreg, thus securing excellent properties.

It is preferred that the content of the soluble liquid crystal oligomer in accordance with the present invention is 5 to 50 wt % based on the total insulating composition. When the content of the soluble liquid crystal oligomer is less than 5 wt %, thermal characteristics are deteriorated, for example, a coefficient of thermal expansion is increased. Further, when exceeding 50 wt %, it is not preferred since chemical resistance is deteriorated.

It is preferred that the epoxy resin included in the insulating composition of the present invention is a multifunctional epoxy resin having two or more epoxy groups in one molecule. For a concrete example, the epoxy resin in accordance with the present invention may be a phenol glycidylether epoxy resins such as a phenol novolac epoxy resin, a cresol novolac epoxy resin, a naphthol-modified novolac epoxy resin, a bisphenol A epoxy resin, a bisphenol F epoxy resin, a biphenyl epoxy resin, or a triphenyl epoxy resin; a dicyclopentadiene epoxy resin having a dicyclopentadiene backbone; a naphthalene epoxy resin having a naphthalene backbone; a dihydroxy benzopyran epoxy resin; a glycidyl amine epoxy resin derived from polyamine such as diaminophenylmethane; a triphenolmethane epoxy resin; a tetraphenylethane epoxy resin; or mixtures thereof. Among them, a naphthalene epoxy resin having a naphthalene backbone or an aromatic amine epoxy resin is preferred.

It is preferred that the content of the epoxy resin in accordance with the present invention is 5 to 50 wt % based on the total insulating composition. When the content of the epoxy resin is within the above range, it is preferred to improve thermal stability while maintaining peel strength.

Further, the insulating composition of the present invention includes the inorganic filler to reduce the coefficient of thermal expansion, and it is preferred that the inorganic filler has a diameter of 0.05 to 2 μm. The kind of the inorganic filler is not particularly limited, but for a concrete example, the inorganic filler may be at least one selected from the group consisting of natural silica, fused silica, amorphous silica, hollow silica, aluminum hydroxide, boehmite, magnesium hydroxide, molybdenum oxide, zinc molybdate, zinc borate, zinc stannate, aluminum borate, potassium titanate, magnesium sulfate, silicon carbide, zinc oxide, boron nitride (BN), silicon nitride, silicon oxide, aluminum titanate, barium titanate, barium strontium titanate, aluminum oxide, alumina, clay, kaoline, talc, calcined clay, calcined kaoline, calcined talc, mica, short glass fibers, and mixtures thereof. Among them, silica, alumina, silicon carbide, and boron nitride can be particularly preferably used.

The inorganic filler may be used by being dispersed with a size of several nanometers to several tens of micrometers or by being mixed without dispersion.

It is preferred that the content of the inorganic filler in accordance with the present invention is 50 to 80 wt % based on the total insulating composition. When the content of the inorganic filler is less than 50 wt %, it is not preferred to reduce the coefficient of thermal expansion. Further, when exceeding 80 wt %, it is not preferred since the peel strength is deteriorated.

Additionally, in order to improve processability, the insulating composition in accordance with the present invention may further include at least one rubber component selected from the group consisting of elastomers such as polyurethane resins, polybutadiene, butadiene-acrylonitrile copolymers, polychloroprene, butadiene-styrene copolymers, polyisoprene, butyl rubber, fluorinated rubber, and natural rubber, styrene-isoprene rubber, acrylic rubber, epoxidized butadiene, and maleated butadiene.

It is preferred that the rubber component is included in an amount of 0.5 to 10 wt % based on the total insulating composition in terms of processing such as manufacture of a film, a prepreg, and a substrate as well as maintenance of heat-resistance.

Further, in the present invention, it is preferred to use a specific solvent to improve the solubility of the soluble liquid crystal oligomer. For a concrete example, the solvent may be halogen solvents such as 1-chlorobutane, chlorobenzene, 1,1-dichloroethane, 1,2-dichloroethane, chloroform, and 1,1,2,2-tetrachloroethane; ether solvents such as diethyl ether, tetrahydrofuran, and 1,4-dioxane; ketone solvents such as methyl ethyl ketone (MEK), acetone, and cyclohexanone; acetate solvents such as propylene glycol monomethyl ether acetate (PGMEA); ester solvents such as ethyl acetate; lactone solvents such as γ-butyrolactone; carbonate solvents such as ethylene carbonate and propylene carbonate; amine solvents such as triethylamine and pyridine; nitrile solvents such as acetonitrile; amide solvents such as N,N′-dimethyl formamide (DMF), N,N′-dimethyl acetoamide (DMAc), tetramethylurea, and N-methylpyrrolidone (NMP); nitro solvents such as nitromethane and nitrobenzene; sulfide solvents such as dimethylsulfoxide (DMSO) and sulfolane; phosphate solvents such as hexamethylphosphoramide and tri-n-butylphosphate; or combinations thereof. Among them, N-methylpyrrolidone (NMP), dimethylsulfoxide (DMSO), N,N′-dimethyl formamide (DMF), N,N′-dimethyl acetoamide (DMAc), methyl ethyl ketone (MEK), propylene glycol monomethyl ether acetate (PGMEA), or combinations thereof may be preferably used, and among them, N,N′-dimethyl formamide (DMF) and N,N′-dimethyl acetoamide (DMAc) are most preferable due to their strong polarity in terms of the solubility of the LCO.

Further, 40 wt % of methyl ethyl ketone (MEK) or 2-methoxy ethanol (2ME) may be mixed with N,N′-dimethyl formamide (DMF) or N,N′-dimethyl acetoamide (DMAc). A mixed solvent is normally used to easily adjust a degree of dryness when drying by changing a boiling point.

Further, it is more effective since the solvents easily permeate each layer of the nanoclay in properly dispersing the nanoclay as their polarity increases.

Further, in the present invention, a well-known thermoplastic resin may be added to the insulating composition in order to improve the processibility of the film. Unless deteriorating the properties desired in the present invention, the present invention may include other curing agent, curing accelerator, leveling agent, flame retardant, etc according to the need in addition to the composition listed above. Further, the insulating composition in accordance with the present invention may further include at least one additive such as a filler, a softener, a plasticizer, an antioxidant, a flame retardant, an auxiliary flame retardant, a lubricant, an antistatic agent, a coloring agent, a heat stabilizer, a light stabilizer, a UV absorber, a coupling agent, or an anti-settling agent.

Hereinafter, a method for preparing an insulating composition for a multilayer printed circuit board in accordance with the present invention will be described. The insulating composition for a multilayer printed circuit board in accordance with the present invention may be prepared through the steps of dispersing nanoclay in a solvent, mixing a liquid crystal oligomer with the dispersion; and mixing an epoxy resin and an inorganic filler with the mixture.

In the present invention, it is preferred that the nanoclay is previously dispersed in the solvent for the uniform dispersion of the nanoclay.

The solvent used at this time may be at least one selected from the group consisting of N,N′-dimethyl formamide (DMF), N,N′-dimethyl acetoamide (DMAc), N-methylpyrrolidone (NMP), dimethylsulfoxide (DMSO), N-methylpropionamide, N-methylcaprolactam, γ-butyrolactone, dimethylimidazolidinone, tetramethylphosphoric amide, ethyl cellosolve acetate, methyl ethyl ketone (MEK), propylene glycol monomethyl ether acetate (PGMEA), and combinations thereof. Among them, N,N′-dimethyl formamide (DMF) and N,N′-dimethyl acetoamide (DMAc) are most preferable.

It is more preferred that the nanoclay is split dispersed in the form of a plate with a thickness of 1 nm and a length of 30 to 100 nm to be uniformly dispersed in the soluble liquid crystal oligomer or the epoxy resin or to form a composite with the soluble liquid crystal oligomer and the epoxy resin.

In the next step, the soluble liquid crystal oligomer is added to be mixed with the dispersion in which the nanoclay is dispersed. It is preferred that the soluble liquid crystal oligomer or the soluble liquid crystal oligomer solution prepared by dissolving the soluble liquid crystal oligomer in the solvent listed above is mixed.

In the last step, the remaining components such as an epoxy resin, a curing agent, an inorganic filler, and other additives are mixed to prepare the final insulating composition.

In accordance with an embodiment of the present invention, a prepreg using the insulating composition may be provided.

The prepreg may be prepared by applying the insulating composition to a reinforcing material or impregnating the insulating composition into the reinforcing material, curing the insulating composition, and drying the insulating composition to remove a solvent. For example, the impregnation method may be dip coating, roll coating, etc but not limited thereto.

For example, the reinforcing material may be woven glass cloth, woven alumina glass fibers, glass fiber non-woven fabrics, cellulose non-woven fabrics, woven carbon fibers, polymer fabrics, etc. Further, the reinforcing material may be glass fibers, silica glass fibers, carbon fibers, alumina fibers, silicon carbide fibers, asbestos, rock wool, mineral wool, gypsum whisker, and woven fabrics or non-woven fabrics thereof, aromatic polyamide fibers, polyimide fibers, liquid crystal polyester, polyester fibers, fluoride fibers, polybenzoxazole fibers, glass fibers with polyamide fibers, glass fibers with carbon fibers, glass fibers with polyimide fibers, glass fibers with aromatic polyester, glass paper, mica paper, alumina paper, kraft paper, cotton paper, paper-glass combined paper, etc.

The prepreg in accordance with the present invention may be combined with copper. That is, the prepreg, which is prepared by performing a heat treatment process in a semi-cured state after impregnating the insulating composition into the reinforcing material, may be heat-treated after being positioned on a copper foil. When removing the solvent and performing the heat treatment, a member obtained by combining the copper and the prepreg is manufactured. The solvent may be evaporated by methods such as heating under reduced pressure or ventilation. For example, the application method may be roller coating, dip coating, spray coating, spin coating, curtain coating, slit coating, screen printing, etc.

Further, in accordance with an embodiment of the present invention, an insulating film may be formed using a solution of the insulating composition. Specifically, a film may be formed on a substrate by forming a solution layer of the insulating composition through solvent casting and removing a solvent from the solution layer. The substrate may be a metal foil such as a copper foil, an aluminum foil, a gold foil, or a silver foil, a glass substrate, a PET film, etc.

Further, in accordance with the present invention, a printed circuit board including a prepreg and an insulating film, which are prepared using the insulating composition, as an insulating layer is provided. The printed circuit board may consist of a film, a print board, a copper clad laminate, a prepreg, or combinations thereof. The printed circuit board may be a copper clad laminate (CCL) or a flexible CCL.

The printed circuit board may be used by being modified variously. A conductor pattern may be formed on one or both surfaces of the printed circuit board, and the conductor pattern may be formed in a multilayer structure such as four layers or eight layers.

Since the insulating composition in accordance with the present invention can be used as an insulating material of various printed circuit boards by having good peel strength in a heat treatment temperature below 220° C., satisfying embeddability of a pattern, soldering heat resistance, and moisture resistance, and having excellent electrical characteristics, dimensional stability, and mechanical characteristics at the same time.

Hereinafter, preferred embodiments of the present invention will be described in detail. The following embodiments merely illustrate the present invention, and it should not be interpreted that the scope of the present invention is limited to the following embodiments. Further, although certain compounds are used in the following embodiments, it is apparent to those skilled in the art that equal or similar effects are shown even when using their equivalents.

### Embodiment 1

### Preparation of Insulating Composition

After adding 157.03 g (50 wt %) of silica slurry and 1.255 g (1 wt % based on silica) of nanoclay (nanofil 116, montmorillonite unsubstituted with an organic modifier) to a 600 mL beaker, the mixture is stirred for 1 hour by a high speed stirrer. 150 g of an LCO solution (Mn 3000 to 5000 g/mol, dissolved in DMAc as solvent, solids content of LCO 50 wt %) is added to the stirred solution and stirred for 1 hour. Finally, 50 g of an epoxy resin (MY-721, Huntsman) and 0.5 g of a curing agent (DICY) are added and stirred for 2 hours to prepare an insulating composition in accordance with the present invention.

### Embodiment 2

### Manufacture of Insulating Film

A film is manufactured by applying the insulating composition prepared in the embodiment 1 on a shiny surface of a 12 μm copper foil with a thickness of 100 μm by a doctor blade method. The applied film is dried for 2 hours at room temperature and additionally dried again in a vacuum oven for 1 hour at 80° C. and for 1 hour at 110° C. to be partially cured. Further, the film is stacked using a vacuum press to be completely cured (maximum temperature 230° C., maximum pressure 2 MPa).

### Comparative Example 1

An insulating composition without addition of nanoclay to the insulating composition of the embodiment 1 is prepared, and an insulating film is manufactured in the same manner as the embodiment 2.

### Experimental Example 1

### Measurement of Thermal Characteristics

Coefficients of thermal expansion are measured using TMA (TA company Q400) to evaluate thermal characteristics of the manufactured insulating films. Temperature raising conditions are as follows, and the results of measurement are shown in the following table 1.

Temperature raising conditions:
1 cycle: raise temperature by 10° C. per minute from 10° C. to 250° C.
2 cycle: drop temperature by 10° C. per minute from 250° C. to 10° C.
3 cycle: raise temperature by 10° C. per minute from 10° C. to 310° C.

(calculate CTE values through dimensional changes of 3 cycles)

### Experimental Example 2

### Measurement of Mechanical Characteristics

Tensile strength and glass transition temperature (Tg) are measured using DMA (TA company Q800) to evaluate mechanical characteristics of the manufactured insulating films. A temperature raising condition is 3° C./min, and a frequency is 1 hour. The results of measurement are shown in the following table 1.

| | Coefficient of | Coefficient of | | |
|---|---|---|---|---|
| | Thermal | Thermal | | |
| | Expansion (α1, | Expansion (α2, | Tensile | |
| | ppm/° C.) | ppm/° C.) | Strength | Tg |
| | (α1: 50~150° C.) | (α2: 250~300° C.) | (Gpa) | (° C.) |
| Embodiment 2 | 34.69 | 87.81 | 9.1 | 200 |
| Comparative | 35.14 | 129.6 | 9.1 | 200 |
| Example 1 | | | | |

As in the results of the table 1, the coefficient of thermal expansion (α2) of the insulating film prepared from the insulating composition in accordance with the present invention is reduced by 32.4% compared to the comparative example 1. The tensile strength and the Tg aren't relatively improved since they are more likely to be influenced by a resin, but the reduction of the coefficient of thermal expansion (α2) in the range of 250 to 300° C. which is a temperature condition of a reflow process of a printed circuit board to which the material is to be applied is connected directly with a reduction of warpage which is the biggest defective factor of a substrate process.

From these results, it is possible to explain that the mechanical properties are improved by allowing the polar group bonded to the surface of the nanoclay included in the insulating composition and the functional groups such as carbonyl and amide of the soluble liquid crystal oligomer to form a covalent bond.

### Experimental Example 3

### Cross-Sectional Analysis

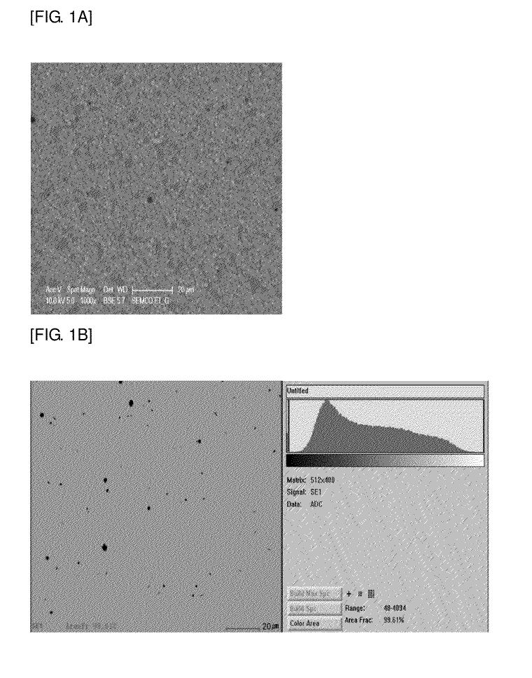

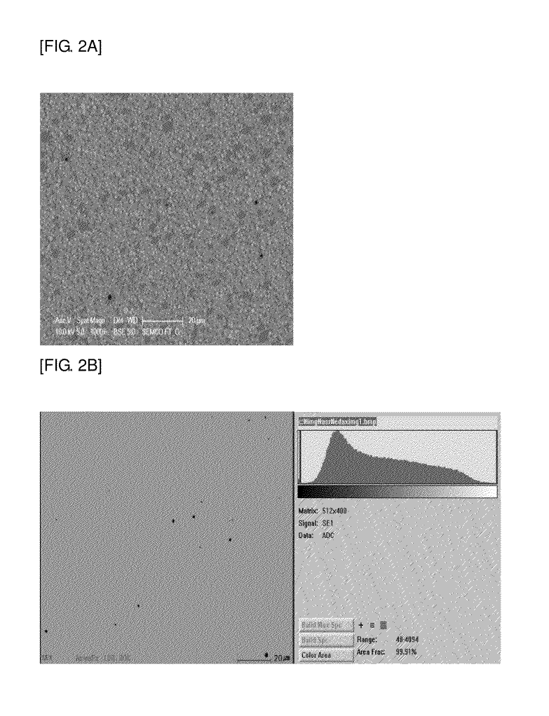

Measurement is performed using a scanning electron microscope (SEM) to check the dispersion state of the inorganic filler through cross-sections (a) and image analysis (b) of the insulating films prepared in the comparative example 1 and the embodiment 2, and the results thereof are shown in FIGS. 1 and 2, respectively. Further, a frequency of micropores is measured by analyzing an image obtained by observing the cross-section of the film through the SEM into a color image according to reflectivity of electrons due to elements to adjust the micropores to be marked as black.

As can be seen from FIGS. 1 and 2, the frequency of micropores of the insulating film of the embodiment 2 calculated by the image analysis method is 0.09%, and the frequency of micropores of the insulating film prepared from the insulating composition of the comparative example 1 is calculated as 0.39%.

From these results, as a result of color analyzing of the SEM image, it is possible to check that the micropores in the insulating composition to which the nanoclay is added are effectively reduced since the dispersion stability of the inorganic filler in the composition is excellent.

According to the embodiment of the present invention, the composition, which is prepared by mixing nanoclay with a soluble liquid crystal oligomer (LCO), an epoxy resin, and an inorganic filler having excellent thermal, electrical, and mechanical characteristics, can be implemented as a substrate insulating material such as a prepreg or a film which can implement a low efficient of thermal expansion, high rigidity, and high thermal characteristics required for a package substrate with advanced specifications.

Further, the composition can secure processability which can form a low roughness for forming a fine circuit pattern in a state in which low permittivity and hygroscopicity are basically secured while having heat resistance and mechanical strength as well as a low coefficient of thermal expansion, a high glass transition temperature, and high rigidity.

What is claimed is:

1. An insulating composition for a multilayer printed circuit board, comprising:
nanoclay 0.5 to 10 wt %, a soluble liquid crystal oligomer 5 to 50 wt %, an epoxy resin 5 to 50 wt %, a solvent 5 to 40 wt %, and an inorganic filler 50 to 80 wt %.

2. The insulating composition for a multilayer printed circuit board according to claim 1, wherein the nanoclay is montmorillonite surface-treated with cations; or montmorillonite surface-treated with quaternary ammonium salt containing aliphatic hydrocarbon or an alkyl group having 6 to 18 carbon atoms.

3. The insulating composition for a multilayer printed circuit board according to claim 1, wherein the nanoclay is completely split dispersed in the soluble liquid crystal oligomer or the epoxy resin in the form of a nanometer-thick plate or
the nanoclay is included in the form of a composite with the soluble liquid crystal oligomer or the epoxy resin.

4. The insulating composition for a multilayer printed circuit board according to claim 1, wherein the liquid crystal oligomer includes hydroxyl groups and nadimide functional groups at terminals thereof.

5. The insulating composition for a multilayer printed circuit board according to claim 1, wherein a number average molecular weight (Mn) of the liquid crystal oligomer is 3000 to 5000 g/mol.

6. The insulating composition for a multilayer printed circuit board according to claim 1, wherein the epoxy resin is a multifunctional epoxy resin having two or more epoxy groups in one molecule.

7. The insulating composition for a multilayer printed circuit board according to claim 1, wherein a diameter of the inorganic filler is 0.05 to 2 μm.

8. The insulating composition for a multilayer printed circuit board according to claim 1, wherein the inorganic filler is at least one selected from the group consisting of natural silica, fused silica, amorphous silica, hollow silica, aluminum hydroxide, boehmite, magnesium hydroxide, molybdenum oxide, zinc molybdate, zinc borate, zinc stannate, aluminum borate, potassium titanate, magnesium sulfate, silicon carbide, zinc oxide, boron nitride (BN), silicon nitride, silicon oxide, aluminum titanate, barium titanate, barium strontium titanate, aluminum oxide, alumina, clay, kaoline, talc, calcined clay, calcined kaoline, calcined talc, mica, short glass fibers, and mixtures thereof.

9. The insulating composition for a multilayer printed circuit board according to claim 1, wherein the solvent is at least one selected from the group consisting of N,N′-dimethylformamide (DMF), N,N′-dimethylacetamide (DMAc), N-methylpyrrolidone (NMP), dimethyl sulfoxide (DMSO), N-methylpropionamide, N-methylcaprolactam, γ-butyrolactone, dimethylimidazolidinone, tetramethylphosphoric amide, ethyl cellosolve acetate, methyl ethyl ketone (MEK), propylene glycol monomethyl ether acetate (PGMEA), and combinations thereof.

10. The insulating composition for a multilayer printed circuit board according to claim 1, additionally further comprising:
at least one rubber component selected from the group consisting of elastomers such as polyurethane resins, polybutadiene, butadiene-acrylonitrile copolymers, polychloroprene, butadiene-styrene copolymers, polyisoprene, butyl rubber, fluorinated rubber, and natural rubber, styrene-isoprene rubber, acrylic rubber, epoxidized butadiene, and maleated butadiene.

11. The insulating composition for a multilayer printed circuit board according to claim 10, wherein the rubber component is included in an amount of 0.5 to 10 wt % based on the total composition.

12. A method for preparing an insulating composition for a multilayer printed circuit board, comprising:
dispersing nanoclay in a solvent;
mixing a liquid crystal oligomer with the dispersion; and
mixing an epoxy resin and an inorganic filler with the mixture.

13. The method for preparing an insulating composition for a multilayer printed circuit board according to claim 12, wherein the solvent is at least one selected from the group consisting of N,N′-dimethylformamide (DMF), N,N′-dimethylacetamide (DMAc), N-methylpyrrolidone (NMP), dimethyl sulfoxide (DMSO), N-methylpropionamide, N-methylcaprolactam, γ-butyrolactone, dimethylimidazolidinone, tetramethylphosphoric amide, ethyl cellosolve acetate, methyl ethyl ketone (MEK), propylene glycol monomethyl ether acetate (PGMEA), and combinations thereof.

14. The method for preparing an insulating composition for a multilayer printed circuit board according to claim 12, wherein the nanoclay is split dispersed in the form of a plate with a thickness of 1 nm and a length of 30 to 1000 nm.

15. A prepreg or an insulating film using an insulating composition according to claim 1.

16. A multilayer printed circuit board comprising a prepreg or an insulating film using an insulating composition according to claim 1 as an interlayer insulating layer.
